(19) United States
(12) Patent Application Publication
(10) Pub. No.: US 2010/0157569 A1
(43) Pub. Date: Jun. 24, 2010

(54) METHOD OF IMAGING A SUBJECT USING A LIGHT DIFFUSION BALLOON

(76) Inventor: Anthony Vietro, Studio City, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/341,565

(22) Filed: Dec. 22, 2008

(51) Int. Cl. G03B 15/06; F21V 11/00

(52) U.S. Cl. 362/16; 362/355

(57) ABSTRACT

A method of using a light diffusion balloon to image a subject is shown and described. The balloon is inflated with a balloon gas that is lighter than air and is placed between a source of light such as the sun and a subject to be imaged. When inflated, the balloon has a length, width, and thickness, and the thickness is less than both the length and the width. The balloon gas has a molecular weight less than that of air, and in one example is helium.

### TECHNICAL FIELD

The disclosure generally relates to light diffusion balloons, and in particular, the imaging of subjects exposed to natural light diffused with a light diffusion balloon. In particular, the light diffusion balloons are useful in television and motion picture filming and photography.

### BACKGROUND

To improve image quality when filming or photographing subjects exposed to light, it is frequently desirable to diffuse the light to reduce its incident intensity on the subject. This can be particularly difficult if the light source is a natural light source (e.g., the sun) because of its non-directional nature and its large exposure area. One known device for diffusing natural light is known as a “fly swatter.” A fly swatter consists of a large (e.g., 20 ft.×20 ft.) frame in which a translucent, non-transparent cloth is tautly stretched and mounted. The frame is attached to a crane and elevated over the subject to be imaged such that light from the natural light source is diffused through the cloth, and the diffused light is projected on to the subject. When the frame is attached to the crane it gives the appearance of a conventional fly swatter, which is why it bears that name.

Flyswatters have several drawbacks. First, they require the use of cranes, which are expensive and can be cumbersome to use. Cranes have limited ability to access areas near large structures such as buildings or trees. Also, the size of the frame that can be supported by a crane is necessarily limited by the maximum torque that the crane can withstand when the frame is elevated. As the frame becomes larger, the torque to which the crane is subjected increases as does the possibility of tipping the crane. As a result, most cranes can only support one 20 ft.×20 ft. frame and when large areas are being filmed or photographed, several flyswatters—and corresponding cranes—must be used.

Lighting balloons are often used to diffuse a source of illumination contained in the balloon. However, many lighting balloons are not designed or otherwise well-suited for use in diffusing natural light. Thus, a need has arisen for a method of diffusing light in the imaging of a subject which addresses the foregoing issues.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1A is side elevational view of a light diffusion balloon in a deflated condition;

FIG. 1B is a perspective view of a light diffusion balloon in an inflated condition;

FIG. 2 is a side elevation view of the light diffusion balloon of FIG. 1B in use in the filming of a subject;

FIG. 3 is a light diffusion balloon assembly comprising several detachably connected light diffusion balloons; and

FIG. 4 is a side elevation view of two light diffusion balloons in use in the filming of a subject.

### DETAILED DESCRIPTION

As discussed in detail below, a method of imaging a subject is provided in which a light diffusion balloon is placed between a natural light source (e.g., the sun), and a subject to be imaged (e.g., photographed, filmed, or videotaped). Light from the natural light source passes through the balloon and exits the balloon as diffuse light which is projected on the subject being imaged. This diffusion reduces the harshness of the light source which may be unflattering or otherwise unsuitable for imaging the subject. Sun light on a clear day may be particularly harsh and may create undesirable levels of contrast on a subject.

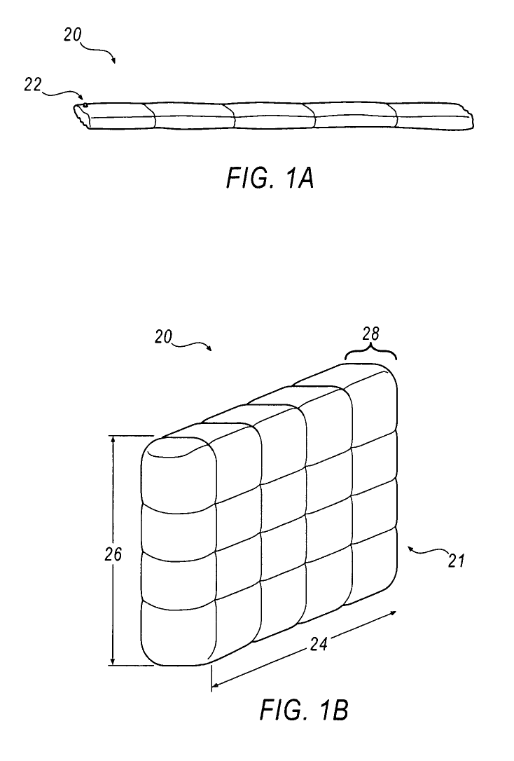

Referring to FIG. 1A, a light diffusion balloon 20 is shown in a deflated condition. Light diffusion balloon 20 comprises a translucent textile, such as a grid cloth or a sail cloth. Grid cloth typically has a cross-hatched construction like a weave or rip stop nylon. If desired, the inner surface of light diffusion balloon 20 may be coated with a film that prevents or at least retards the rate of diffusion of balloon gas from the interior of balloon 20.

Light diffusion balloon 20 is preferably not transparent and provides an F-stop reduction of at least about ¼ F-Stop, more preferably at least about ½ F-Stop, and even more preferably at least about 1 F-Stop. The textile preferably provides an F-stop reduction of not more than about 5 F-stop, more preferably not more than about 4 F-Stop, and even more preferably not more than about 3 F-Stop. In one example, the textile provides an F-Stop reduction of about 1 F-Stop. In another example, the textile provides an F-Stop reduction of not more than about 2 F-Stop.

Light diffusion balloon 20 also includes at least one valve 22 which provides a means for connecting a balloon gas source to inflate balloon 20 from the deflated condition of FIG. 1A to the inflated condition of FIG. 1B. Valve 22 is a standard valve of the type known to those skilled in the art for allowing the inflation of lighting balloons.

The balloon gas used to inflate light diffusion balloon 20 is preferably one that will allow light diffusion balloon 20 to float above the ground during the imaging of a subject. As is known to those skilled in the art, in order for a balloon to rise, it must be filled with a gas that has a density (at the prevailing conditions) lighter than that of the ambient air. If the balloon gas and ambient air are subjected to the same temperature and pressure, the ratio of their densities will generally equal the ratio of their respective molecular weights. Therefore, in a preferred embodiment, the balloon gas has a molecular weight less than that of air, which is approximately 29 g/gmol.

The buoyancy of a balloon gas used to elevate a balloon can be characterized by the “buoyant mass” of the gas:

Buoyant Mass=mass of balloon gas×(1−ρ_{Pair}/ρ_{balloon gas}) (1)

If the buoyant mass is 0 or greater, the balloon gas will not elevate the balloon regardless of its uninflated mass. If the buoyant mass is less than 0, the balloon gas will elevate a balloon having an uninflated mass less than the buoyant mass. Therefore, the gas volume within the balloon (internal volume) will determine the balloon weight (in a deflated condition) that can be elevated. To obtain balloon lift, the minimum balloon internal volume is that which provides a buoyant mass equal to the mass of the deflated balloon given the density of the balloon gas. In the illustrative case of a hot air balloon, the air within the balloon must remain heated in order for its density to remain less than that of the ambient air. Otherwise the buoyant mass will decline, eventually reaching zero when the balloon air reaches the same temperature as the ambient air.

The balloon gas is preferably selected such that the ratio of the balloon gas molecular weight to the molecular weight of air is no greater than about 0.5. Ratios of no greater than about 0.3 are more preferred, ratios of no greater than about 0.2 are even more preferred, and ratios of no greater than about 0.15 are still more preferred. If multiple balloon gases are used, the ratio of the average molecular weight of the balloon gases (at their respective molar concentrations) to that of air will preferably fall within these ranges.

Balloon gases such as helium, hydrogen, ammonia, and methane may be used. However, inert balloon gases are preferred, and helium is especially preferred. The molecular weight of helium is 4 g/mol, so the ratio of its molecular weight to that of air is about 0.14. Balloon 20 is preferably selected to minimize or reduce the leakage of the balloon gas. In certain embodiments, a coating is provided on the interior surface of the balloon to prevent leakage, especially if the balloon gas has a small molecular radius relative to any porous openings in the light diffusion balloon 20. Such coatings are known to those skilled in the art of balloon design.

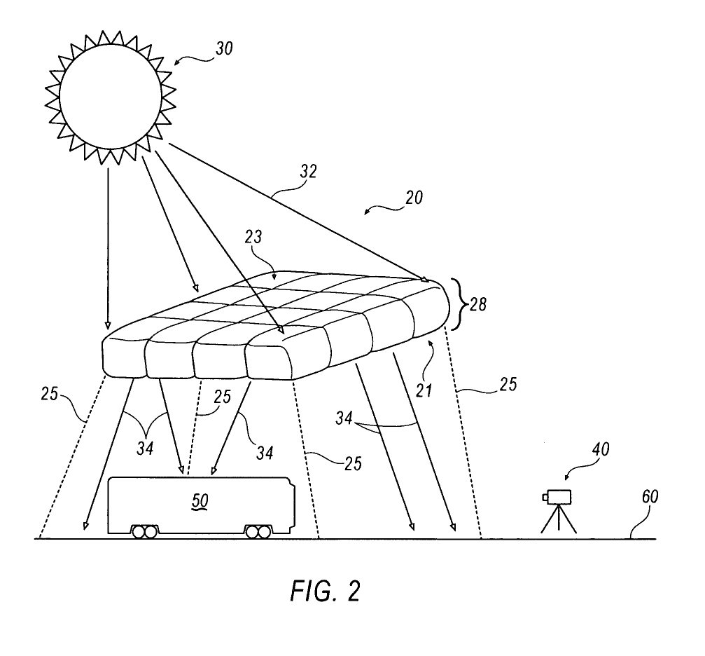

Light diffusion balloon 20 may have a variety of shapes when inflated, including cubes, spheres, discs, cylinders, cones, ellipsoids, etc. However, for use in diffusing natural light, light diffusion balloon 20 is preferably in the general shape of a rectangular prism when inflated, as shown in FIG. 1B. A rectangular prism is sometimes referred to as a “cuboid,” i.e., it has six sides, each of which are generally rectangular in shape. When inflated, the light diffusion balloon 20 of FIGS. 1B and 2 appears much like a typical air mattress. As a result, light diffusion balloon 20 has a length 24, a width 26, and a thickness 28. Both length 24 and width 26 are preferably greater than thickness 28. Surface 21 and opposing surface 23 (not shown in FIG. 1B) are the surfaces through which most of the light will pass when light diffusion balloon 20 is in use. The ratio of the thickness 28 to the length 24 is preferably no greater than about 0.5, more preferably no greater than about 0.3, and even more preferably no greater than about 0.2. The ratio of the thickness 28 to the length 24 is preferably no less than about 0.05, more preferably no less than about 0.08, and even more preferably no less than about 0.1.

The ratio of the length 24 to width 26 is preferably no greater than about 2, more preferably no greater than about 1.5, and even more preferably no greater than about 1. In one example, length 24 is 20 feet, width 26 is 20 feet, and thickness 28 is 3 feet.

As indicated above, when in the inflated condition of FIG. 1B, the internal volume of light diffusion balloon 20 is preferably sufficient to hold the amount of balloon gas that is required to elevate the weight of the uninflated balloon 20 to a desired height. In certain examples, the internal volume is preferably at least about 800 ft³, more preferably at least about 1000 ft³, even more preferably at least about 1100 ft³, and most preferably at least about 1150 ft³. Internal volumes of no greater than about 2,000 ft³ are preferred, and internal volumes of no greater than about 1,500 ft³ are more preferred. Internal volumes of no greater than about 1,300 ft³ are especially preferred. In one example, light diffusion balloon 20 has an internal volume of about 1,200 ft³.

Referring to FIG. 2, a method of using light diffusion balloon 20 to image a subject 50 is depicted. Subject 50 may be animate or inanimate and may include any type of subject, including people, animals, geographical locations and formations, vehicles, buildings, etc. In the example of FIG. 2, subject 50 is a bus.

Balloon 20 is shown in its inflated condition and is elevated above subject 50. The internal volume of balloon 20 is filled with a sufficient amount of a balloon gas having a molecular weight less than that of air to cause light diffusion balloon 20 to rise. As a result, tethering lines 25 are used to secure light diffusion balloon 20 to a tethering object which is of sufficient weight to anchor light diffusion balloon 20 in place. In one example, tethering lines 25 are attached to the ground 60 with spikes. In another example, bags of sand or other objects are placed on the free ends of tethering lines 25 to secure them to the ground 60. However, balloon 20 may be secured to buildings, trees, vehicles, or any other mobile or stationary object that will not be elevated or carried away by the buoyant force of the balloon gas.

As shown in FIG. 2, natural light source 30 (the sun) projects rays, some of which are illustrated as rays 32. Rays 32 are incident upon surface 23 of light diffusion balloon and penetrate through its thickness 28. Rays 32 exit light diffusion balloon 20 at surface 21 as diffuse light rays 34, some of which are illustrated in FIG. 2. The area of the ground covered by the diffuse light rays 34 (which typically appears as a shadow generated by light diffusion balloon 20) is referred to as the “diffused area” herein.

Subject 50 is thus exposed to diffuse light rays 34 and protected from direct exposure to natural light rays 32. Imaging device 40 is provided and may be a camera, video camera, etc. which is positioned with subject 50 in its field of view. The imaging device operator uses device 40 to create a still or moving image of subject 50 as it is exposed to diffuse light rays 34.

In FIG. 2, light diffusion balloon 20 is depicted as generally parallel to the ground 60. However, it may be oriented at a variety of different angles with respect to ground 60, as long as its orientation relative to subject 50 is sufficient to allow diffuse light rays 34 to be projected on to subject 50 while shielding subject 50 from natural light rays 32. Some or all of subject 50 may be placed at a location that is not underneath light diffusion balloon 20 if the orientation is adjusted appropriately relative to the natural light source 30. In particular the angle of light diffusion balloon 20 with respect to ground 60 may depend on the position of the natural light source 30 relative to ground 60. Thus, at midday when the sun 30 is overhead, light diffusion balloon 20 will generally be positioned parallel to ground 60 while it may be angled with respect to ground 60 earlier or later in the day.

In the imaging of subjects exposed to natural light, light diffusion balloon 20 can advantageously be placed close to or over trees, buildings etc. if the proper tethering lines 25 are provided and if the internal volume and balloon gas are selected to provide the required degree of lift. Thus, light diffusion balloon 20 does not suffer from many of the drawbacks of flyswatters because it avoids the need for a crane. In one example, one or more light diffusion balloons are transported in an uninflated condition to an imaging location where imaging is to take place. The one or more diffusion balloons are then tethered to appropriate tethering objects and inflated until they lift to a height sufficient to maintain generally taut tethering lines.

Light diffusion balloon 20 is also transportable from one location to another in an inflated condition. Referring again to Example 2, if subject 50 is being moved, light diffusion balloon 20 can be untethered from ground 60 and moved in an inflated condition along with subject 50 so that subject 50 may be imaged as it moves. In addition, after subject 50 is imaged in the location depicted in FIG. 2, tethering lines 25 may be detached from the ground 60, and the light diffusion balloon 20 may be moved to another location to image the same subject 50 or a different subject. Thus, light diffusion balloon 20 can be moved between imaging locations without the need to transport cranes or other heavy equipment as is required in the case of flyswatters.

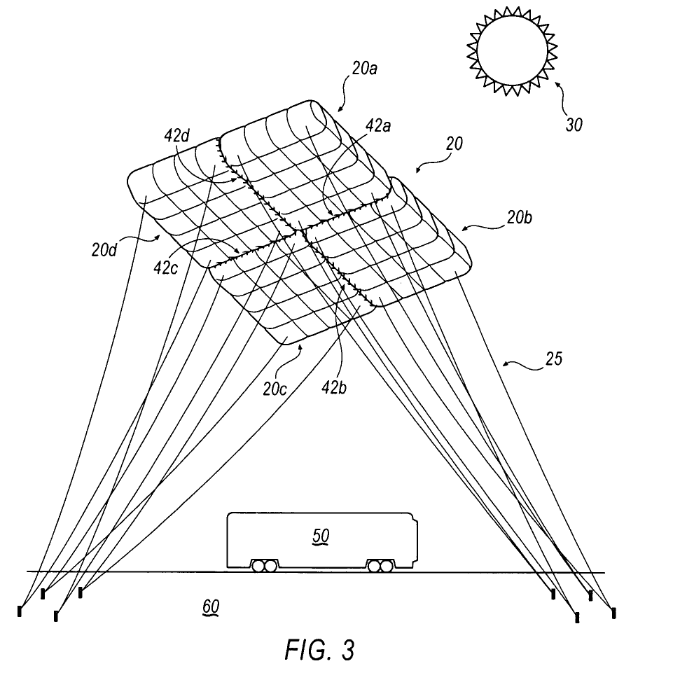

In certain illustrative examples, a light diffusion balloon assembly is provided. Referring to FIG. 3, light diffusion balloon assembly 20 comprises four light diffusion balloons 20a, 20b, 20c, and 20d. The use of light diffusion assembly 20 allows a user to effectively increase the area of light diffusion by detachably connecting multiple light diffusion balloons 20a-20d together. Light diffusion balloon 20a is detachably connected to adjacent light diffusion balloon 20b by detachable connector 42a and to adjacent light diffusion balloon 20d by detachable connector 42d. Light diffusion balloon 20b is connected to light diffusion balloon 20a by detachable connector 42a and to light diffusion balloon 20c by detachable connector 42b. Light diffusion balloon 20c is detachably connected to light diffusion balloon 20b by detachable connector 42b and to light diffusion balloon 20d by detachable connector 42c. Light diffusion balloon 20d is connected to light diffusion balloon 20a by detachable connector 42a and to light diffusion balloon 20c by detachable connector 42b. Thus, the effective width of light diffusion balloon assembly 20 is the sum of the widths of light diffusion balloons 20b and 20c (or the sum of the widths of balloons 20a and 20d), while its effective length is the sum of the lengths of light diffusion balloons 20d and 20c (or 20a and 20b). In one example, each light diffusion balloon 20a-20d has its own discrete internal volume and its own inflation valve (such as valve 22 in FIG. 1A). In another example, the internal volumes of each light diffusion balloon 20a-20d are in fluid communication with one another.

Detachable connectors 42a-42d may be any suitable device that allows a user to connect light diffusion balloons 20a-20d to one another and then detach them from one another. Suitable connectors include zippers, snaps, buttons, hooks, clasps, Velcro, ropes or other flexible lines, etc. In one preferred example, zippers are used. Subject to space and tethering limitations, any number of light diffusion balloons can be connected to one another to provide whatever effective area of light diffusion that is required. By detachably connecting multiple light diffusion balloons, a variety of shapes such as rectangles, T-shapes, L-Shapes, I-Shapes, and pyramid shapes may be formed to tailor the diffused light area to the subject being imaged and/or the imaging location. If multiple light diffusion balloons 20a-20d are used, they may be transported to the imaging location in an uninflated condition, detachably connected to one another, and then inflated to obtain the necessary degree of lift to produce generally taut tethering lines.

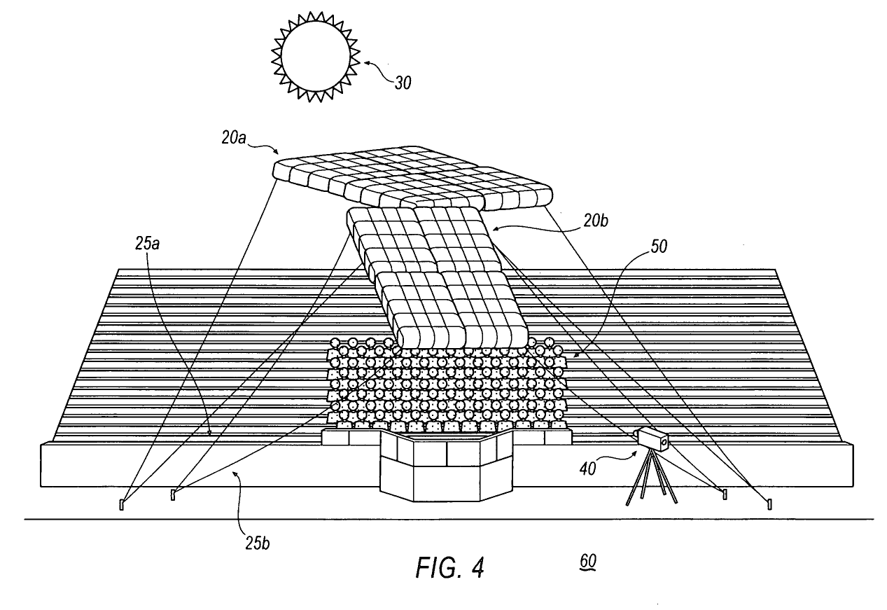

In addition to detachably connecting multiple light diffusion balloons 20a-20d, multiple light diffusion balloons may be tethered adjacent one another in an unconnected configuration to increase the area or shape of the diffused light area. Referring to FIG. 4, two light diffusion balloons 20a and 20b are shown in their inflated conditions. Light diffusion balloons 20a and 20b are each independently tethered to ground 60 by respective sets of tethering lines, 25a and 25b which are secured to the ground in the manner discussed previously. Light diffusion balloons 20a and 20b are not connected to one another, but are elevated relative to subject 50 and are positioned adjacent one another to define an overall balloon area that is generally in the shape of a “T.” Subject 50, which in the illustrative example of FIG. 4 is a crowd of people seated on bleachers, is exposed to diffused light emanating from light diffusion balloons 20a and 20b and is in the field of view of imaging device 40. As FIG. 4 indicates, any number of light diffusion balloons may be flown near one another to create a variety of diffused light areas having different geometric shapes and sizes. In addition, either or both balloons 20a and 20b may be repositioned at the same location for further imaging with device 40, and they may be moved as desired to other locations for further imaging.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A method of imaging a subject, comprising:
providing at least one light diffusion balloon;
placing the at least one light diffusion balloon between a source of natural light and the subject; and
imaging the subject.

2. The method of claim 1, wherein the at least one light diffusion balloon is elevated relative to the subject such that natural light from the source of natural light is diffused by the balloon to produce diffused natural light, and the subject is exposed to the diffused natural light.

3. The method of claim 1, wherein the source of natural light is the sun.

4. The method of claim 1, wherein the at least one light diffusion balloon has an inflated condition in which the at least one light diffusion balloon comprises an internal volume filled with a balloon gas, and the balloon gas has a molecular weight that is less than the molecular weight of air.

5. The method of claim 4, wherein the ratio of the molecular weight of the balloon gas to the molecular weight of air is no more than about 0.5.

6. The method of claim 4, wherein the balloon gas is helium.

7. The method of claim 4, wherein the internal volume is at least about 800 ft³.

8. The method of claim 1, wherein the at least one light diffusion balloon has an inflated condition in which it has a length, a width, and a thickness, and the thickness is less than the length and the width.

9. The method of claim 8, wherein the ratio of the thickness to the length is less than about 0.5.

10. The method of claim 1, wherein the at least one light diffusion balloon has an inflated condition in which the at least one light diffusion balloon is generally in the shape of a rectangular prism.

11. The method of claim 1, wherein the at least one light diffusion balloon comprises a plurality of light diffusion balloons and each light diffusion balloon in the plurality of light diffusion balloons is detachably connected to at least one other light diffusion balloon in the plurality of light diffusion balloons.

12. The method of claim 1, wherein the step of providing the at least one light diffusion balloon comprises providing the at least one light diffusion balloon in a deflated condition, and the method further comprises tethering the deflated light diffusion balloon to at least one tethering object and inflating the deflated light diffusion balloon.

13. The method of claim 1, wherein the subject is a first subject, the step of imaging the first subject comprises imaging the first subject in a first location, and the method further comprises moving the at least one light diffusion balloon to a second location while the at least one light diffusion balloon is in an inflated condition and imaging a second subject in the second location.

14. The method of claim 13, wherein the first subject is the same as the second subject.

15. A method of imaging a subject, comprising:
providing at least one light diffusion balloon, wherein the light diffusion balloon has an inflated condition in which it has a length, a width, and a thickness, and the length is greater than the thickness;
placing the at least one light diffusion balloon between a light source and a subject; and
imaging the subject.

16. The method of claim 15, wherein when the at least one light diffusion balloon is in an inflated condition, the light diffusion balloon is generally in the shape of a rectangular prism.

17. The method of claim 15, wherein the ratio of the thickness to the length is less than about 0.5.

18. The method of claim 15, wherein the light source is a natural light source.

19. The method of claim 18, wherein the natural light source is the sun.

20. The method of claim 15, further comprising inflating the at least one light diffusion balloon.

21. The method of claim 20, wherein the at least one light diffusion balloon has an inflated condition in which it has an internal volume, and step of inflating the at least one light diffusion balloon comprises filling the internal volume with a balloon gas.

22. The method of claim 21, wherein the balloon gas has a molecular weight that is less than the molecular weight of air.

23. The method of claim 15, wherein the step of providing at least one light diffusion balloon comprises providing a plurality of light diffusion balloons and detachably connecting each light diffusion balloon in the plurality of light diffusion balloons to at least one other light diffusion balloon in the plurality of light diffusion balloons.

24. The method of claim 15, wherein the step of providing the at least one light diffusion balloon comprises providing the at least one light diffusion balloon in a deflated condition, and the method further comprises tethering the deflated light diffusion balloon to at least one tethering object, and inflating the deflated light diffusion balloon.

25. The method of claim 15, wherein the subject is a first subject, the step of imaging the first subject comprises imaging the first subject in a first location, and the method further comprises moving the at least one light diffusion balloon to a second location while the at least one light diffusion balloon is in an inflated condition and imaging a second subject in the second location.

26. The method of claim 25, wherein the first subject is the same as the second subject.

27. A light diffusion balloon assembly, comprising:
a first light diffusion balloon, wherein when the first light diffusion balloon is in an inflated condition, the first light diffusion balloon has a first length, a first width, and a first thickness; and
a second light diffusion balloon, wherein when the second light diffusion balloon is in an inflated condition, the second light diffusion balloon has a second length, a second width, and a second thickness, wherein the first light diffusion balloon is detachably connected to the first light diffusion balloon.

28. The light diffusion assembly of claim 27, wherein when the first light diffusion balloon is in an inflated condition, the first light diffusion balloon generally has the shape of a rectangular prism.

29. The light diffusion assembly of claim 28, wherein when the second light diffusion balloon is in an inflated condition, the second light diffusion balloon generally has the shape of a rectangular prism.

30. The light diffusion balloon assembly of claim 27, wherein when the first light diffusion balloon is in an inflated condition, it has an internal volume of at least about 800 ft³.

31. The light diffusion balloon assembly of claim 27, wherein when the first light diffusion balloon is in an inflated condition, the ratio of the thickness to the length is less than about 0.5.

32. The light diffusion balloon assembly of claim 27, wherein the first light diffusion balloon is detachably connected to the second light diffusion balloon by a zipper.

33. The light diffusion balloon assembly of claim 27, wherein the light diffusion balloon assembly further comprises a third light diffusion balloon, and the third light diffusion balloon is detachably connected to the first light diffusion balloon and the second light diffusion balloon.

34. A method of using a light diffusion balloon to image a subject, comprising:
providing at least one light diffusion balloon in an uninflated condition, proximate an imaging location such that the at least one light diffusion balloon is exposed to a natural light source;
tethering the at least one light diffusion balloon to at least one tethering object;
inflating the at least one light diffusion balloon to an inflated condition, wherein natural light from the natural light source is diffused by the inflated at least one light diffusion balloon to produce diffused natural light, and the imaging location is exposed to the diffused natural light;
placing a subject in the imaging location; and
imaging the subject.

35. The method of claim 34, wherein when the at least one light diffusion balloon is in an inflated condition, the at least one light diffusion balloon has an internal volume, and the step of inflating the at least one light diffusion balloon comprises filling the internal volume with a balloon gas.

36. The method of claim 35, wherein the balloon gas has a molecular weight that is less than the molecular weight of air.

37. The method of claim 34, wherein the imaging location is a first imaging location, the at least one tethering object is a first tethering object, and the method further comprises untethering the at least one light diffusion balloon from the first tethering object, moving the inflated at least one light diffusion balloon to a second imaging location, and tethering the inflated at least one light diffusion balloon to a second tethering object.

38. The method of claim 37, wherein the subject comprises a first subject, the step of imaging the subject comprises imaging the first subject in the first imaging location, and the method further comprises imaging a second subject in the second imaging location.

39. The method of claim 38, wherein the first subject is the same as the second subject.

40. The method of claim 34, wherein the at least one tethering object is a first tethering object, the step of providing at least one light diffusion balloon comprises providing first and second light diffusion balloons, the step of tethering the at least one light diffusion balloon to at least one tethering object comprises tethering the first light diffusion balloon to the first tethering object, and the method further comprises tethering the second light diffusion balloon to a second tethering object.
